(19) United States
(12) Patent Application Publication
(10) Pub. No.: US 2009/0165463 A1
(43) Pub. Date: Jul. 2, 2009

(54) Fixing System for a Component of a Turbojet Pod

(75) Inventors: Bernard G Vauchel, Le Havre (FR); Patrick Gonidec, Bretx (FR); Gerard P Rouyer, Saint Romain de Clobosc (FR)

Correspondence Address: OLIFF & BERRIDGE, PLC, P.O. BOX 320850, ALEXANDRIA, VA, 22320-4850, US

(73) Assignee: AIRCELLE, GONFREVILLE L'ORCHER (FR)

(21) Appl. No.: 12/086,304

(22) PCT Filed: Jan. 18, 2007
(86) PCT No.: PCT/FR2007/000088

§ 371 Date: Jun. 10, 2008

(30) Foreign Application Priority Data
Jan. 23, 2006 (FR) 0600563

(51) Int. Cl. F02C 7/20

(52) U.S. Cl. 60/797; 415/213.1

(57) ABSTRACT

The invention concerns a fixing system for at least one component of a pod of a turbojet on an engine strut to which the pod is attached and comprising at least one coupling zone provided by the component capable of co-operating with at least one complimentary coupling zone provided by the strut, and fixing means for providing with complementary fixing means a rigid and detachable connection between said component and the strut. The invention is wherein the fixing means and the complementary fixing means are capable of slightly pivoting relative to each other, as well as relative to a corresponding pod.

The present invention relates to a fixing system for attaching at least one constituent element of a turbojet pod to a connecting strut to which the pod is attached, and to a pod equipped with such a fixing system.

A bypass turbojet comprises an engine housed in a tubular pod the internal wall of which, together with a primary cowl surrounding the engine, defines an annular passage. This pod has an air intake upstream of the engine, thrust reversal means in its central section, and a jet pipe the outlet of which is situated downstream of the engine.

The engine generates two air flows via the blades of a rotating fan, these being a hot air flow termed the primary flow, originating from the combustion chamber of the engine, and a cold air flow called the secondary flow, which flows around the outside of the engine through the annular passage also known as the fan stream duct.

The two air flows are ejected from the turbojet via the rear of the pod. To do this, the turbojet is equipped with a duct behind the fan, known as the jet pipe, the purpose of which is to duct the air flows generated. In general, this duct comprises an internal wall surrounding the structure of the actual engine proper behind the fan and an external wall the upstream part of which lies in the continuation of the engine cowling surrounding the fan. The external wall is able to duct both the secondary flow and the primary flow in its downstream part if the two flows are ejected together, or is able to duct only the secondary flow in the case of so-called separate flow pods.

A wall may also streamline the outside of the primary cowl surrounding the engine so as to minimize the drag of the propulsion unit. This is the case in particular of a propulsion unit attached to the outside of the aircraft, especially when it is attached under a wing or at the rear of the fuselage.

In addition to housing the engine and to ducting the flows, a pod generally houses a collection of ancillary actuating devices associated with its operation and performing various functions when the turbojet is running or stationary.

In general, there are three main ancillary actuating systems incorporated into a pod and these are: the radial opening of cowlings for turbojet maintenance, the deployment and retraction of moving thrust reverser cowls, and the radial opening of the two half-parts of the thrust reverser so that more in-depth maintenance operations can be performed on the engine itself.

To do this, pod structures formed of two half-parts that can open and that may be associated with a primary cowl surrounding the engine are known. Such pods are commonly known as “C-duct” pods in contrast with an “O-duct” pod which does not have removable half-parts.

A “C-duct” structure has the advantage that it offers ease of access to the engine for performing maintenance operations on the ground once the systems that hold the half-parts in place have been unlocked and these half-parts have been pivoted about a longitudinal axis close to the mast or pylon via which the pod is connected to the wing or to the fuselage. The half-parts are joined together at the bottom by latches.

At the present time, engine maintenance and overhaul operations are relatively frequent and access to the engine has therefore to be quick and simple. Present-day “C-duct” pods meet this requirement well.

However, although they meet this requirement for quick and easy access to the engine, the current systems whereby the half-parts of the pod are opened by pivoting have to meet specific criteria in terms of strength and represent a not-insignificant development and manufacturing cost.

More specifically, when the turbojet is pressure loaded, the primary cowl and the external structure defining the fan stream duct experience deformation stresses which are concentrated along the end attachment lines, namely the longitudinal axis about which a half-part pivots and the lower longitudinal axis at which the latches that hold the two half-parts closed are situated.

Furthermore, the opening of the half-parts also entails the presence of opening jacks inside the pod and of link rods that hold the half-parts in the open position. These elements represent a considerable weight and occupy a considerable amount of space.

Yet another disadvantage is that the primary cowl surrounding the engine and the external structure have to be able to be opened simultaneously and therefore have to be joined together. This is performed via a pivot-mounted connection island to which the structures that make up the pod are fixed. This makes the pod as a whole heavier and more complicated to assemble.

Recent advances in technology have enabled the development of engines that require major maintenance or overhaul operations only after approximately each third of the life of the turbojet when used on short-haul and medium-haul routes. As a result, the maintenance operations are performed less frequently and there is a need for a new system for attaching the elements of a pod.

Finally, modern engines have a tendency to incorporate a fan of increasingly large size which means that the engine is generally “wasp-waisted” downstream of the fan. This means that there is a greater flexibility in the structures more sensitive to deformation which therefore have to be fixed more firmly. With a present-day pod structure, a great deal of clearance needs to be provided between the internal blades of the engine and the structure of the pod surrounding these blades in order to avoid any contact between the two during flight.

There are various fixing system in existence that will at least partially solve these problems. It is possible in particular to mention the fixing systems as described in documents GB 2 151 995, U.S. Pat. No. 6,340,135, EP 0 361 901 or, alternatively, EP 1 488 999. However, these systems remain relatively rigid.

It is an object of the present invention to propose an improved system to alleviate the aforementioned disadvantages and, in particular, to propose a fixing system that has a greater tolerance to deformation whilst at the same time making maintenance operations easier.

To achieve this, the present invention consists in a fixing system for attaching at least one constituent element of a turbojet pod to a connecting strut to which the pod is attached and comprising at least one coupling region exhibited by the constituent element and capable of collaborating with at least one complementary coupling region exhibited by the strut, and fixing means capable, together with the complementary fixing means, of achieving a rigid and dismantleable connection between said constituent element and the strut, characterized in that the fixing means and the complementary fixing means are capable of pivoting slightly with respect to one another.

Thus, by providing a rigid and dismantleable fixing system, there is no longer any need to resort to a mobile attachment that will allow the constituent elements to be opened, access for the maintenance operations being gained by dismantling the fixing system and setting down the constituent elements of the pod. The mechanical means, such as lifting systems, needed to move these elements around are independent of the pod and therefore no longer need to be included therein. In addition, the various elements can be fitted and removed independently of one another, making it possible to dispense with some of the connecting members and in particular to reduce the dimensions and mass of the connecting islands. The cost represented by the maintenance devices needed for setting down the constituent elements of the pod is largely compensated for by the elimination of the opening and locking jacks, amongst other possible simplifications. In addition, thanks to a rigid attachment, the risk of two elements contacting each other is reduced and it is therefore possible to reduce the amount of clearance left between the elements.

Furthermore, by providing connecting means capable of pivoting slightly relative to one another, the fixing system has improved tolerance to deformation and greater ease of fitting and removal.

According to a first alternative form of embodiment, the fixing means comprise at least one fitting.

According to a second alternative form of embodiment, the fixing means comprise at least one slide capable of collaborating with a corresponding rail.

According to a third alternative form of embodiment, the fixing means comprise at least one bolt capable of collaborating with a corresponding bore.

According to a fourth alternative form of embodiment, the fixing means are connecting bars attached to the constituent element and mounted in a floating manner through the connecting strut.

Obviously, these alternative forms can possibly be combined with one another.

The present invention also relates to a turbojet pod intended to house an aeroengine and made from a structure comprising at least two half-parts, characterized in that each half-part comprises a fixing system according to the invention.

As a preference, the pod comprises an internal structure intended to surround the engine and an external structure delimiting a fan stream duct with the internal structure, characterized in that the half-parts of at least one of the internal and/or external structures are equipped with a fixing system according to the invention. Advantageously, the half-parts of the two structures are equipped with a fixing system according to the invention.

Advantageously also, the half-parts of the internal structure comprise locking means capable of collaborating with complementary locking means fastened to the fan casing.

As a preference, the pod comprises a bearing surface positioned downstream of the engine and capable of acting as a contact interface between said engine and the internal structure.

Also as a preference, at least one of the half-parts of the external structure comprises at least one inspection hatch.

Implementation of the invention will be better understood with the aid of the detailed description given hereinafter with reference to the attached drawings in which:

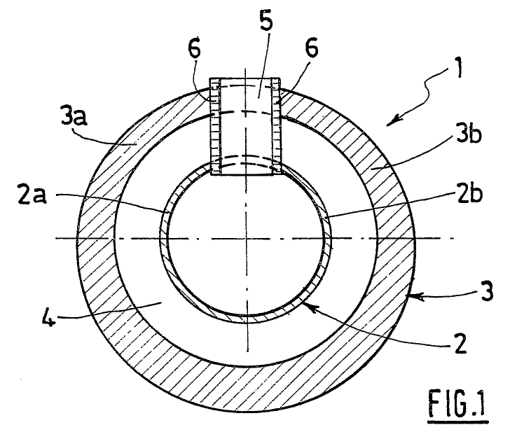

FIG. 1 is a schematic depiction in cross section schematically showing the overall structure of a pod.

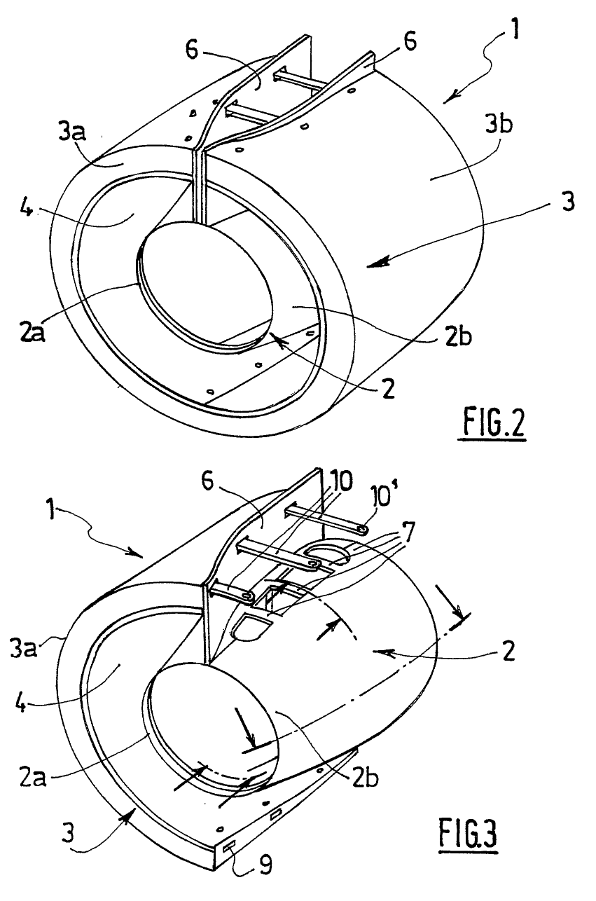

FIGS. 2 and 3 are perspective views of a pod comprising a fixing system according to the prior art, comprising a removable fixing system.

FIG. 4 is a partial view in cross section of the half-parts of the internal structure in the region where they are fixed at the bottom.

FIG. 5 is a partial view in cross section of the half-parts of the internal structure in the region where they are fixed at the top.

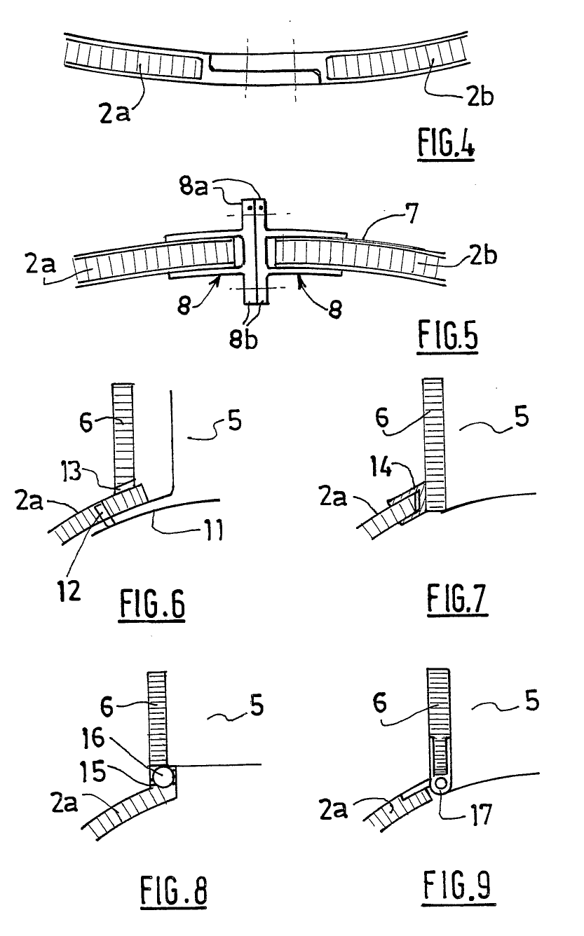

FIGS. 6 to 11 show various ways of fixing the half-parts of the internal structures at the top according to other embodiments and which can be adapted according to the invention if necessary.

FIGS. 12 to 15 show various embodiments of fixing the half-parts of the external structures at the top according to other methods of attachment that can be adapted according to the invention.

FIG. 16 is a partial view in longitudinal section of one particular embodiment of the attachment of the internal structure.

A pod 1 according to the invention as depicted in FIGS. 1 and 2 is intended to house a bypass turbojet engine (not depicted).

This pod 1 has an air intake upstream of the engine, thrust reversal means (not visible) in its central section and a jet pipe (not visible), the outlet of which is situated downstream of the engine.

The pod 1 is made from half-parts assembled to give the pod 1 its tubular shape around the engine and comprises an internal structure 2, or primary cowl, surrounding the structure of the engine and an external structure 3 which, together with the internal structure 2, forms an annular inner duct 4 known as the fan stream duct and intended for the flow of a secondary stream generated by the engine.

The internal structure 2 may also comprise a wall streamlining the outside of the engine in order to minimize the drag of the propulsion unit.

A pod 1 such as this is intended to be attached to a strut 5 providing the connection between the propulsion unit and the airplane. The strut 5 generally extends under the wing and passes through the pod 1 to be anchored in the engine. Lateral structures 6 serve to streamline the strut 5 and elements connecting the airplane and, more precisely, the wing under which the strut 5 is attached, to the engine. These lateral streamlining structures 6 pass through the external structure 3 and the fan stream duct 4 until they reach the internal structure 2 where a gasket may be added to provide sealing. The lateral structures 6 may also be used as cowlings and/or reinforcing structures for the strut 5 itself. They may be attached to the strut 5 or incorporated into it. In its broadest sense, the term strut also encompasses these lateral structures 6.

FIGS. 1 and 2 show a particular embodiment of the fixing of the half-parts 2a, 2b of the internal structure 2 and of the half-parts 3a, 3b of the external structure 3. Other methods of attachment are depicted in the following figures. According to the invention, all these fixings are mounted in such a way as to allow some relative movement between the two parts. More specifically, each fixing system comprises fixing means capable of collaborating with complementary fixing means and are capable of pivoting slightly relative to one another. This ability to pivot may be intrinsic in the fixing means, that is to say that the fixing means naturally comprise means allowing them to pivot in this way, or may require complementary pivoting means.

The two half-parts 2a, 2b of the internal structure 2 are connected together along a lower longitudinal axis and an upper longitudinal axis.

The joint between the two half-parts 2a, 2b at the lower longitudinal axis is made by nesting together complementary shapes, and locking the two half-parts 2a, 2b by bolting. This type of connection is known as customary.

For better structural integrity as the secondary air flow passes through the fan stream duct, the internal structure 2 needs to have the larger surface area of its enclosed structure. At the top, the two half-parts 2a, 2b may (as visible in FIG. 2) have a comb-like structure comprising arms 7 extending each half-part 2a, 2b around the structure of the strut 5. As depicted in FIG. 5, each arm 7 of each half-part 2a, 2b ends in a fitting 8 which has an upper shoulder 8a and a lower shoulder 8b both of which are bolted to the upper 8a and lower 8b shoulders of the fitting 8 with which the corresponding arm 7 of the other half-part 2b, 2a is equipped so as to lock the two half-parts 2a, 2b together.

Access to the lower shoulders 8b is gained via openings defined by the arms 7 and needed for the passage of the strut 5 and other elements that pass through this region.

The surfaces of the internal structure 2 overlapping the strut 5 may, if appropriate, serve as regions for connection therewith.

The two half-parts of the external structure 3 are independent of the internal structure 2 and are also joined together along a lower longitudinal axis and an upper longitudinal axis.

At the bottom, one half-part 3a, 3b has housings 9 formed in the thickness of the external structure 3 along the bottom longitudinal axis while the other, complementary, half-part 3b, 3a has a corresponding male element (not visible) capable of entering the associated housing 9 and being locked therein. Locking is performed by pinning each male element with the other half-part 3a, 3b.

At the top, each half-part 3a, 3b is connected to the strut 5 by means of connecting bars 10 mounted such that they float through the strut 5 and the lateral cowling structures 6, each bar 10 having a first end (not visible) inserted into a housing (not visible) formed in the thickness of one half-part 3a, 3b and a second end 10′ introduced into a corresponding housing (not visible) formed in the thickness of the other half-part 3b, 3a. Each end of the connecting bars 10 is locked to the corresponding half-part 3a, 3b by pinning or bolting, this locking being designed to allow each half-part 3a, 3b to pivot laterally relative to the strut.

In this example, the external structure 3, although attached to the strut 5, is not connected directly either to the latter or to the remainder of the structure of the pod 1 and in particular is completely independent of the internal structure 2.

During the maintenance operation that entails opening the pod 1, all that will then be required will be for the fixing elements to be dismantled and the half-parts 3a, 3b, 2a, 2b to be set down. Unlike traditional pods which open laterally, there is therefore no need to provide jacks for raising the half-parts 3a, 3b, 2a, 2b radially or for securing the half-parts 3a, 3b of the external structure 3 to the half-parts 2a, 2b of the internal structure 2. The ability of the half-parts 3a, 3b to pivot slightly about their fixing means makes this setting down easier.

For a less in-depth maintenance operation hatches may be provided in the external structure 3.

It should be noted that the pod 1 may have the abovementioned structure only in part, for example the intermediate part of the thrust reversers, the setting down of this part providing access to the remainder of the pod 1.

FIGS. 6 to 11 show, without being restricted thereto, various alternative methods of attachment of the two half-parts 2a, 2b that form the internal structure 2.

Although chiefly illustrated using the half-part 2a, these methods of attachment apply equally to the half-part 2b. Obviously, these methods of attachment may possibly be combined with one another. Still according to the invention, the various means of attachment shown can potentially be associated with means of slight pivoting if they do not already have this ability inherent to them.

FIG. 6 shows the attachment of a half-part 2a of the internal structure 2 directly to a lateral extension 11 of the strut 5 using a bolt 12. A gasket 13 provides a seal between the half-part 2a of the internal structure 2 and the lateral cowling structure 6 of the strut 5.

FIG. 7 shows the. attachment of the half-part 2a of the internal structure 2 to the lateral cowling structure 6 incorporated into the strut 5 using a fitting 14. It should be noted that the fitting 14 may be local, continuous over the entire length of the half-part 2a, or alternatively may be made in several parts. It may also, according to the invention and depending on the internal or external part this is used to attach, be mounted on pivoting means.

FIG. 8 shows a connection of the half-part 2a using a longitudinal rail 15 capable of collaborating with a corresponding slide 16 belonging to the strut 5. Obviously, the slide 16 and the rail 15 can be positioned with equal preference on the strut 5 or on the half-part 2a. The rail 15/slide 16 system, here positioned under the lateral structure 6 in the continuation thereof may, as an alternative, be positioned laterally on the strut 5 as shown in FIG. 12 in respect of a half-part 3a of the external structure 3. According to the invention, the rail 15/slide 16 system is configured in such a way as to allow the rail 15 to pivot slightly in the slide 16 or to allow the slide 16 to pivot slightly about the rail 15.

FIG. 9 shows attachment of the half-part 2a using a pivot connection 17 allowing the half-part 2a a small amount of relative movement with respect to the pod 1 as a whole to make setting down easier and improve the tolerance of the half-parts to deformation. Rotation is limited by a stop element 17a.

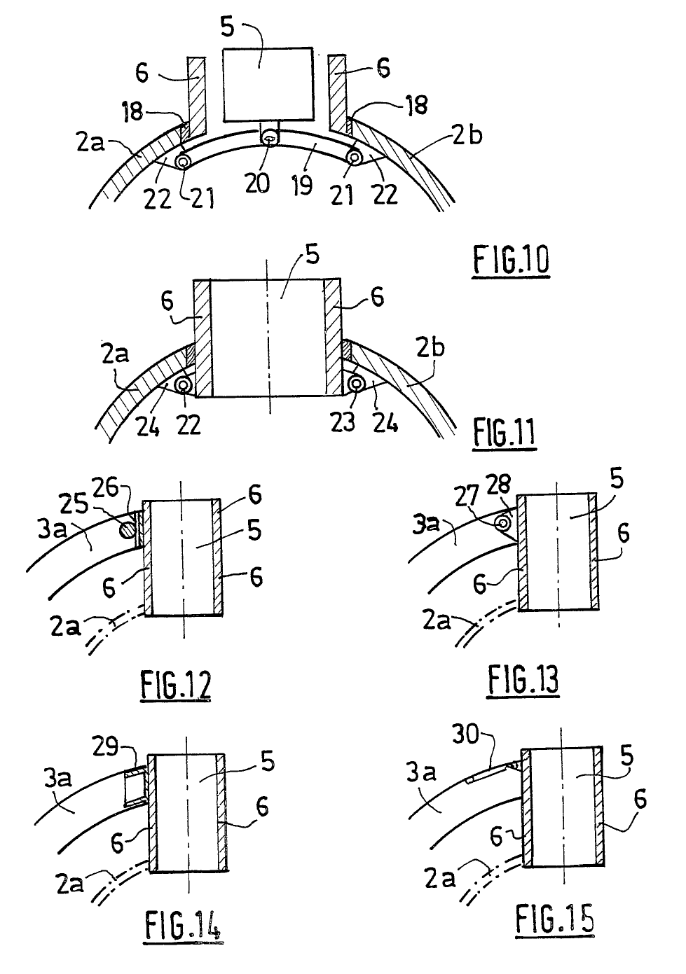

FIG. 10 shows attachment by structural continuity in the vicinity of the strut 5. Specifically, each half-part 2a, 2b comes into contact with the corresponding lateral structure 6 via a gasket 18 extending it and providing a sealing of the internal structure 2. Attachment is via a transverse arm 19 extending on each side of the strut 5 to which it is attached at a point 20, the transverse arm 19 ending on each side in an eye 21 bolted to a corresponding eye 22 secured to the associated half-part 2a, 2b. FIG. 11 also shows attachment by structural continuity without recourse to a transverse arm 19. In this case, each half-part 2a, 2b is locked to the lateral structures 6 of the strut 5 via eyes 23, 24 and bolts secured to the lateral structure 6 and to the half-part 2a, 2b respectively.

FIGS. 12 to 15 show, without being restricted thereto, various alternative methods of attachment of the half-parts 3a, 3b of the external structure. Although illustrated chiefly in respect of the half-part 3a, these methods of attachment equally apply to the half-part 3b. The various means of attachment shown may be associated with means of pivoting in accordance with the invention. Obviously, these means of attachment may potentially be combined with one another and with the methods of attachment of the internal structure 2.

FIG. 12 shows attachment using a slide 25 formed in the half-part 3a of the external structure 3 collaborating with a longitudinal rail 26 secured to the lateral cowling structure 6 of the strut 5 fixed to one side thereof facing the half-part 3a of the external structure 3.

FIG. 13 shows attachment using a horizontal spindle 27 pinned to a fitting 28 secured to the strut 5. Obviously, the assembly can with equal preference be mounted either on the strut 5 or on the half-part 3a of the external structure 3.

FIG. 14 illustrates attachment by direct connection by bolting the half-part 3a of the external structure 3 to the lateral cowling structure 6 or the strut 5 using fittings 29. Obviously, the fittings 29 may be secured to the strut 5 or to the half-part 3a with equal preference.

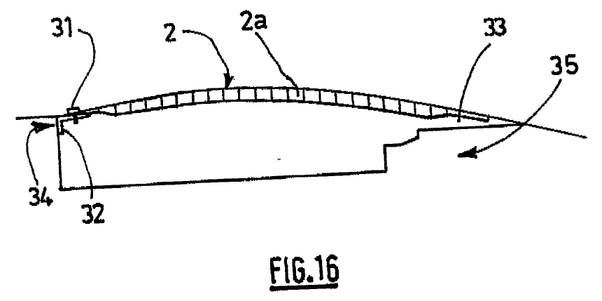

FIG. 15 shows the possibility of attaching each half-part 3a, 3b of the external structure 3 to the strut 5 or to a lateral cowling structure 6 using latches 30. In addition, if the two half-parts 3a, 3b protrude upstream or downstream beyond the strut 5, then the two half-parts can be joined together directly using this means.

Obviously, all the methods of attachment described in respect of the half-parts 2a, 2b of the internal structure 2 and the half-parts 3a, 3b of the external structure 3 are not restricted to these half-parts 2a, 2b, 3a, 3b and may be readily combined with one another.

FIG. 16 shows a particular method of attachment of the internal structure 2 to the engine in the longitudinal view that may or may not supplement a method of attachment already described. In this configuration, the internal structure 2 is fixed using a number of bolts 31 to a flange 32 fastened to the fan casing 34. Other means of connection such as peripherally encircling the internal structure between a knife-edge secured to the internal structure 2 and a receiving flange connected to the engine (or vice versa) or alternatively a series of latches may be used. In order to reduce the deformation stresses to which the structure 2 is subjected, this structure at the downstream end rests on a bearing surface 33 surrounding the engine 35 and intended to allow differential expansion between the two elements without giving rise to stresses in these elements. A bearing surface such as this, on the one hand, structurally enhances the engine 35 and, on the other hand, allows the mass of certain structural elements to be optimized. This bearing surface 33 may be continuous or discontinuous on the periphery, partial, elastic or rigid.

Although the invention has been described in conjunction with some specific examples of embodiments, it is quite obvious that it is not in any way restricted thereto and that it encompasses all technical equivalents of the means described and combinations thereof where these fall within the scope of the invention. It should in particular be noted that the present invention is not restricted to the half-parts that incorporate the thrust reversal functions but may also cover the cowl surrounding the fan casing and possibly any cowl that makes up a pod.

1. A fixing system for attaching at least one constituent element of a turbojet pod to a connecting strut to which the pod is attached and comprising at least one coupling region exhibited by the constituent element and capable of collaborating with at least one complementary coupling region exhibited by the strut, and fixing means capable, together with the complementary fixing means, of achieving a rigid and dismantleable connection between said constituent element and the strut, wherein the fixing means and the complementary fixing means are capable of pivoting slightly with respect to one another.

2. The fixing system as claimed in claim 1, wherein the fixing means comprise at least one fitting.

3. The fixing system as claimed in claim 1, wherein the fixing means comprise at least one slide capable of collaborating with a corresponding rail.

4. The fixing system as claimed in claim 1, wherein the fixing means comprise at least one bolt capable of collaborating with a corresponding bore.

5. The fixing system as claimed in claim 1, wherein the fixing means are connecting bars attached to the constituent element and mounted in a floating manner through the connecting strut.

6. A turbojet pod intended to house an aeroengine and made from a structure comprising at least two half-parts wherein each half-part comprises a fixing system as claimed in claim 1.

7. The turbojet pod as claimed in claim 6, wherein it comprises an internal structure intended to surround the engine and an external structure delimiting a fan stream duct with the internal structure, wherein the half-parts of at least one of the internal and/or external structures are equipped with a fixing system as claimed in claim 1.

8. The pod as claimed in claim 7, wherein the half-parts of the two structures are equipped with a fixing system as claimed in claim 1.

9. The pod as claimed in claim 7, wherein the half-parts of the internal structure comprise locking means capable of collaborating with complementary locking means fastened to the fan casing.

10. The pod as claimed in claim 7, wherein it comprises a bearing surface positioned downstream of the engine and capable of acting as a contact interface between said engine and the internal structure.

11. The pod as claimed in claim 6, wherein at least one of the half-parts of the external structure comprises at least one inspection hatch.
